(19) United States
(12) Patent Application Publication
(10) Pub. No.: US 2004/0185192 A1
(43) Pub. Date: Sep. 23, 2004

(54) Image-recordable, image-recording medium and adhesive sheet structure

(76) Inventors: Hiroshi Tsuji, Yamagata (JP); Seiji Iino, Yamagata (JP)

Correspondence Address: 3M INNOVATIVE PROPERTIES COMPANY, PO BOX 33427, ST. PAUL, MN, 55133-3427, US

(21) Appl. No.: 10/490,832

(22) PCT Filed: Sep. 4, 2002
(86) PCT No.: PCT/US02/28034

(30) Foreign Application Priority Data
Oct. 23, 2001 (JP) 2001-324890

(51) Int. Cl. B41M 5/00

(52) U.S. Cl. 428/32.12

(57) ABSTRACT

An image-recordable liner comprising a support, a release layer which is fixed to one surface of the support and comprises a release agent composition, and a recording layer which consists of a layer comprising a resin fixed to the other surface of the support and receives an ink or a toner for recording an image; and an adhesive sheet structure comprising a substrate, at least one adhesive layer which is fixed to one surface of the substrate and contains a self-adherent polymer, and the above image-recordable liner, which is laminated on the adhesive layer with the release layer facing to the adhesive layer.

### TECHNICAL FIELD

This invention relates to liners and adhesive sheet structures and more particularly to image recordable liners and adhesive sheet structure.

### BACKGROUND OF THE INVENTION

A conventional adhesive sheet comprises a substrate and an adhesive layer provided on at least one main surface of the substrate, and the adhesive surface of the adhesive layer is usually covered with a liner. The function of the liner is to protect the adhesive layer before the adhesive sheet is used. In particular, in the case of an adhesive sheet which comprises an adhesive layer containing a self-adherent polymer having high tack of the adhesive surface, foreign materials such as dusts easily adhere to the adhesive surface, when the adhesive sheet is shipped and stored without protection with the liner.

As is well known, a liner is a laminate film (or sheet) comprising a support having two main surfaces, and a release layer, which is fixed to one main surface of the support and has a release property with an adhesive layer of an adhesive sheet. The release layer is usually formed of a release agent composition comprising a silicone polymer, a fluoropolymer, etc. The support is made of paper or a polymer film, and usually it is made of a polymer film when a transparent liner is desired. For example, the transparent liner is desired when the adhesive sheet is a transparent protective film having an adhesive layer (which is sometimes called an overlay film or an overlaminate film), since the protective film should be laminated on a surface to be protected, and plane sizes or figures are adjusted (trimmed) without removing the liner.

Thus, the conventional liner should be present before the adhesive sheet is used, but it is removed from the adhesive sheet and then discarded. The discarded liner is usually incinerated On the other hand, from the viewpoint of the protection of environments, it is required to reduce amounts of wastes and materials to be incinerated and to recycle materials as much as possible.

Typically, an image-recording medium usually comprises (1) a support and (2) a recording layer fixed to one main surface of the support, and an image is recorded on the recording layer to provide an image-displaying sheet. The recording layer is necessary for the improvement of the absorption and fixing of a printing toner or ink, and the increase of color-developing properties and durability (less wearing after relatively long use) of the image recorded.

An image is formed (recorded) on the recording layer using a printing toner or ink by a printing method such as electrostatic printing, silk screen printing, gravure printing, offset printing, ink-jet printing, etc. When the image should be protected, a transparent protective film is usually provided over the image on the recording layer. The image usually includes designs, symbols, drawings, characters, letters, etc. and is preferably a decorative image.

For example, the electrostatic printing process includes a direct printing process in which an image to be recorded is printed directly on the recording surface of the recording medium and a transfer process in which an image is impermanently printed on a temporary support, and then the image is transferred to the recording layer of the medium. A specific example of the latter transfer process is an electrostatic printing system of 3M “Scotch® Printing System”. In this system, a printed image is formed on a temporary support which is named a transfer medium, and then the image is transferred to an image-recording medium with heating under pressure to finish a decorative sheet. The image is usually made from a toner or toners, and the recording layer is usually a resin layer, which has thermoplasticity at the above heating temperature to facilitate the transfer of the toner(s). The printing toner comprises a binder resin (usually comprising a mixture of a vinyl chloride-vinyl acetate copolymer and an acrylic resin, etc.) and a pigment dispersed in the binder resin.

The electrostatic printing process comprises forming an electrostatic pattern with a recording head on the recording medium or the temporary support, and then attracting and fixing the toner to the electrostatic pattern. The recording head moves in relation to the recording surface of the recording medium or the temporary support and scans the recording surface to form the electrostatic pattern. In this step, the recording medium or the temporary support may be moved while the recording head is fixed.

The scanning with the recording head (which may be called a printing head) in the printing step is the same in the ink-jet printing process. In the case of the ink-jet printing process, an ink is selectively ejected toward the recording medium to print the image.

An image-recording medium comprising a support and a recording layer both having a high light transmittance is also known. They should be light-transmittable as a whole before the recording of the image, since they are usually used together with an image-projector such as an overhead projector (OHP). Furthermore, the toners or the inks other than black one are also light-transmittable. The recorded image is formed so that it provides a non-reverse image when it is seen from the recording layer side, and light from the projector is illuminated on the image-recorded medium from the main surface of the support opposite to the recording layer, and the image is projected on a screen.

Furthermore, some image-recording media comprises a support having an image-recording layer on the surface of the support and a layer containing a release material on the back surface of the support. For example, an image-recording medium comprises a support, a thermal color developing recording layer formed on the surface of the support, a thermal release layer on the back surface of the support, and a layer of a thermally fusible transfer ink which is temporarily adhered to the thermal release layer. This image-recording medium is used with laminating the image-recording medium on a printing medium to be printed so that the layer of the thermally fusible transfer ink is in contact with the printing medium. When a thermal recording head is in contact with the recording layer, an image is formed in an area which develops a color through the chemical change in the thermal color developing recording layer and, at the same time, the thermally fusible transfer ink is transferred from the layer of the thermal color developing recording layer to the printing medium so that the image is formed on the printing medium. That is, the thermal release layer is used to release the thermally fusible transfer ink when the thermal head is in contact with the recording layer. Here, the recorded image is formed so that it provides a non-reverse image when it is seen from the recording layer side, but the image cannot be seen from the side of the release layer formed on the back surface of the support.

In another medium, an electrically conductive layer containing a release material is provided on the back surface of a support. The conductive layer contains a silicone oil, a fluorine based oil or a wax having a softening point of at least 60° C. as a release material. The conductive layer functions to prevent the deposition of dusts or blocking (adhesion of stuck media) when the image-recorded media are used or stored. The addition of the filler is advantageous to prevent the blocking, but deteriorates the transparency of the conductive layer. Therefore, the recorded image is formed so that it provides a non-reverse image when it is seen from the recording layer side.

An image-recording medium comprising a support, an ink-receptive layer formed on the surface of the support, and a releasable layer which is white or colored and formed on the back surface of the support is disclosed. The releasable layer is used to impart the, anti-blocking properties to the medium like the above-described conductive layer. Furthermore, this releasable layer can be easily cut with cutting means such as a cutter or a needle and easily removed from the support. Examples of resins used to form such a releasable layer include nitrile rubber, urethane rubber, vinyl chloride-vinyl acetate copolymer, vinyl chloride-vinylidene chloride copolymer, polystyrene resin, polyacrylate resin, polyamide resin, cellulose resin. Since the releasable layer is opaque and thus the image should be seen from the recording layer side, the image is formed to provide a non-reverse image when it is seen from the recording layer side.

It is known that a hologram-recording medium comprises a support having, on its surface, a light-sensitive layer on which a hologram can be formed, and a release layer formed on the back surface of the support. The release layer is usually formed from a silicone resin. The release layer is effective to allow the recording medium to be rolled without blocking. Since the hologram is seen from the recording layer side, it is formed to provide a non-reverse image when it is seen from the recording layer side.

### SUMMARY OF THE INVENTION

Briefly, the present invention provides an image-recordable liner, which can be used as an image-recording medium or a medium on which an image is recorded without being discarded after it is peeled and separated from an adhesive sheet, and an adhesive sheet structure comprising such a liner.

According to another aspect of the present invention, the above problem is solved with an image-recordable liner comprising:

(a) a support having two main surfaces,

(b) a release layer which is fixed to one of the main surfaces of said support and comprises a release agent composition, and

(c) a recording layer which consists of a layer comprising a resin fixed to the other main surface of said support and receives an ink or a toner for recording an image.

According to yet another aspect of the present invention, the above problem is solved with an adhesive sheet structure comprising

(A) a substrate having two main surfaces,

(B) at least one adhesive layer which is fixed to one of the main surfaces of said substrate and contains a self-adherent polymer, and

(C) an image-recordable liner according to claim 1, which is laminated on said adhesive layer with said release layer facing to said adhesive layer.

The present invention relates to a liner which can be used as a liner of an adhesive sheet comprising an adhesive layer containing a self-adherent polymer and which can form an image-displaying sheet, that is, an image-recordable liner. The image-recordable liner of the present invention has a release layer on one main surface of a support and an image-recording layer on the other main surface, and can be used as an image-recording medium.

Advantageously, the present invention discloses the use of an image-recording medium as a liner of an adhesive layer, and furthermore the use of such a liner as an image-recording medium or a medium on which an image is recorded (an image-displaying sheet) after being peeled and removed from the adhesive sheet.

### DESCRIPTION OF THE PREFERRED EMBODIMENT(S)

The image-recordable liner of the present invention comprises (a) a support having two main surfaces, (b) a release layer which is fixed to one of the main surfaces of the support and comprises a release agent composition, and (c) a recording layer which consists of a layer comprising a resin fixed to the other main surface of the support and receives an ink or a toner for forming (recording) an image. Thus, this liner can be used as a liner of an adhesive sheet comprising an adhesive layer which contains a self-adherent polymer and has relatively high tack, and also it can be reused as an image-recording medium.

Preferably, the release layer can be peeled off from such an adhesive sheet without the self-adherent polymer being transferred to the release layer, after laminating the adhesive layer and the release layer, press adhering the adhesive sheet and the image-recordable liner with reciprocating a roller of 2 kg two times over them to form a laminate and then maintaining the laminate at 20° C. for 48 hours. Thereby, the liner of the present invention can be used as a liner of the adhesive sheet comprising the adhesive layer containing the self-adherent polymer, and advantageously reused as an image-recording medium.

The image-recordable liner of the present invention is firstly used as the liner of the adhesive sheet, and then used as an image-recording medium while it is being laminated on the adhesive sheet or after it is peeled off from the adhesive sheet so that the adhesive sheet is used. That is, the liner, which has been discarded after use, can be reused as an image-recording medium or an image-displaying sheet on which an image is recorded.

Although the applications of the image-recordable liner of the present invention as the image-recording medium are not limited, the liner of the present invention is preferably used as follows:

The support, the release layer and the image-recording layer are made of materials having relatively high light transmittance, so that the image-recordable liner has a light transmittance of at least 70% when it is measured with illuminating the liner from the release layer side. Then, the image-displaying sheet is formed from this image-recordable liner having an image, which is recorded with an ink or a toner on the surface of the recording layer so that the image can be seen as a non-reverse image through the release layer. The image-displaying sheet formed is used as a poster or a banner film by displaying the sheet with the release layer facing observers. In such a displaying way, the recording layer and the image recorded are present on the back surface side which is difficult to be touched by the observers, and the release layer and the support function as protective films of the image. For example, the release layer comprising a silicone release agent composition has high transparency and high stain-proofing properties. Since the silicone release agent has excellent stain-proofing properties against organic materials, it can effectively prevent the adhesion of oily stains so that it prevents graffiti with oily inks. Thus, the silicone release agent can prevent the deterioration of the appearance and visibility of the image due to the stain of the surface of the image-displaying sheet.

When the liner of the present invention is used as the transparent image-recording medium described above, the light transmittance of the image-recording medium (the image-recordable liner) is preferably at least 80%, more preferably at least 90%. Herein, the light transmittance is measured according to JIS K 7105 “Method for Measuring Light Transmittance”.

Image-recordable Liner.

The image-recordable liner of the present invention is preferably produced by utilizing a liner having no recording layer, which is used together with an adhesive sheet (hereinafter referred to as a “conventional liner”), and fixing a recording layer onto the back surface of the conventional liner opposite to the release surface. The conventional liner has a support, and a release layer which is fixed to one surface of the support and has release properties with an adhesive layer containing a self-adherent polymer.

The release layer preferably has the following release property with an adhesive sheet having an adhesive layer containing a self-adhesive polymer.

That is, the release property of the release layer is such that, when the image-recordable liner of the present invention is press adhered to an adhesive sheet having a peel strength of 20 to 30 N/25 mm, which is measured after press adhering the adhesive sheet to a melamine coated plate as an adherent at 20° C., the adhesive sheet can be removed from the release layer without leaving the self-adherent polymer on the release layer. When the release layer has the above-described release property with the adhesive layer having the relatively high peel strength as described above, the liner of the present invention can be used as a liner of the adhesive sheet comprising the adhesive layer containing the self-adherent polymer.

In the above peeling test of the image-recordable liner, the liner and the adhesive sheet are laminated with the adhesive layer of the adhesive sheet facing the release layer of the liner and then they are press adhered each other by reciprocating a roller of 2 kg twice to obtain a laminate, and the laminate is maintained at 20° C. for 48 hours, and thereafter the adhesive sheet is peeled from the liner. In this test, it is preferable that the adhesive sheet can be peeled from the liner without the self-adherent polymer being transferred to the release layer. Here, the peeling angle of the adhesive sheet is about 180 degrees.

The peel strength of the adhesive sheet at 20° C. is carried out as follows:

The adhesive sheet is cut to a size of 200 mm×25 mm and adhered to a stoved melamine coated plate as an adherent at 20° C. with a press roll according to JIS Z 0237 8.2.3. to obtain a test sample. After the completion of adhesion, the sample was kept standing at the same temperature for 48 hours. Then, a 180 degree peel strength is measured with a tensile tester (e.g. TENSILON, etc.) at a peeling rate of 300 mm/min.

The adhesive sheet used in this test is a single-coated or double-coated adhesive sheet comprising a substrate of a polyethylene terephthalate (PET) film having a thickness of 50 to 100 μm and the above adhesive layer on one or both of the main surfaces of the substrate.

The adhesive layer used in the above test may be formed as follows:

A monomer mixture (50 wt. parts of butyl acrylate, 33 wt. parts of 2-ethylhexyl acrylate, 10 wt. parts of methyl acrylate and 7 wt. parts of acrylic acid) is dissolved in a certain solvent, usually a mixed solvent of toluene and ethyl acetate) and solution polymerized to obtain a self-adherent polymer. To the solution of the self-adherent polymer having a solid content of 30 wt. %, 0.2 wt. part of isophthaloyl bis(2-methylaziridine) to prepare the solution of the adhesive composition. Then, the above adhesive layer is formed from the dried coating film of the solution of the adhesive composition. The thickness of the adhesive layer is usually from 30 to 40 μm.

The weight average molecular weight (Mw) of the above self-adherent polymer measured with GPC is preferably from 300,000 to 600,000.

To achieve the good release property described above, the release layer is preferably formed of a coating layer of a release agent composition containing a silicone polymer. The silicone polymer is usually a modified silicone, which may be polydimethylsiloxane in which a part of the methyl groups in the side chains bonded to the backbone (the siloxane (—Si—O—) backbone) are replaced with organic groups other than the methyl groups, while the rest of the methyl groups are left unreplaced. Examples of such organic groups include an alkyl group having at least two carbon atoms, a phenyl group, an aralkyl group, a fluoroalkyl group. The organic group may have a reactive functional group (e.g. a mercapto group). The release layer may contain additives such as a heat stabilizer, a UV-ray absorber, an antistatic agent, an antioxidant, a dye, a pigment.

The support is usually a polymer sheet or film. The polymer forming the support may be a synthetic polymer such as polyester, polyvinyl chloride, ionomers, acrylic polymers, polyolefin, polyurethane. The support may be a laminated one having two or more layers. The support may contain additives such as a heat stabilizer, a UV-ray absorber, an antistatic agent, an antioxidant, a dye, a pigment.

Examples of the commercial products of the conventional liner are a PET film-TETRON® film having a release layer (available from TEUTIN Co., Ltd.), a PP film-TELEFAN® BO (available from TORAY Co., Ltd.).

The image-recordable liner of the present invention can be produced by fixing the recording layer to the back surface of such a conventional liner. The details of the recording layer will be explained below.

The total thickness of the image-recordable liner is usually from 50 to 300 μm, preferably from 70 to 200 μm. When the total thickness of the liner is too high, it may be difficult to feed the liner to a printing machine when the liner is printed. When the total thickness of the liner is too low, the liner may be broken or wrinkled in the step of printing. The thickness of the support is usually from 40 to 150 μm, preferably from 50 to 120 μm. When the thickness of the support is too high, it may be difficult to feed the liner to a printing machine when the liner is printed. When the thickness of the support is too low, the liner may be broken or wrinkled in the step of printing.

The thickness of the release layer may be in a usually range such that it can be used as the liner of the adhesive sheet, and is preferably in a range where the total thickness of the image-recordable liner is not too thick and the liner can be easily fed to the printing machine, and the adhesive sheet can be peeled off. The thickness of the release layer is usually from 0.1 to 50 μm, preferably from 0.5 to 30 μm.

Recording layer.

The recording layer is fixed on the back surface (the other main surface) of the support and comprises a resin. The recording layer has a back surface facing to the support side, and a surface which receives an ink or a toner for forming an image. That is, the recording surface of the recording layer is the surface of the above resin layer.

The resin in the recording layer is preferably one that can receive the toner or ink. For example, when the image is formed on the recording surface by the electrostatic printing-transferring method, the resin is preferably a thermoplastic resin so that the toner can easily be thermally transferred. Furthermore, the resin in the recording layer is preferably the same as the binder resin in the toner. Preferable examples of the resin include polyester, vinyl chloride polymers (e.g. vinyl chloride copolymers such as vinyl chloride-vinyl acetate copolymers, etc.), acrylic polymers, polyolefin copolymers (e.g. ethylene-vinyl acetate copolymers, etc.). The functions of the recording layer are to be adhered firmly to the back surface of the liner, and to fix the toner in the toner-transferring step under heat and pressure to form a clear image on the recording surface in the case of the transfer printing. In addition, the resin in the recording layer preferably has a melting point of at least 40° C. so that it does not cause blocking with the substrate of the adhesive sheet or the second liner for the double-coated adhesive sheet (the details of which will be explained later) at room temperature (about 25° C.) in a rolled state. The upper limit of the melting point depends on the transfer temperature and is usually 150° C. or less.

When a coloring material for printing is a liquid such as an ink, the resin having a high affinity with such a liquid is preferably selected

The recording layer may be formed by providing a coating liquid containing the resin described above, and coating and drying the coating liquid. A coating means is usually a coater such as a bar coater, a knife coater, a roll coater, a die coater.

The recording layer or the layers in the recording layer may contain additional additives such as a coagulant, a surfactant, a heat stabilizer, a UV-ray absorber, an antistatic agent, an antioxidant. The thickness of the recording layer may be in a range where the image recorded is clearly seen, and the total thickness of the image-recordable liner is within the range described above. The thickness of the recording layer is usually from 8 to 120 μm, preferably from 10 to 100 μm.

Adhesive Sheet Structure.

The adhesive sheet structure of the present invention comprises (A) a substrate having two main surfaces, (B) at least one adhesive layer which is fixed to one of the main surfaces of the substrate and contains a self-adherent polymer, and (C) an image-recordable liner according to the present invention, which is laminated on the adhesive layer with the release layer facing to the adhesive layer.

The adhesive sheet may be produced in an elongated form and wound along its longitudinal direction to obtain a roll-form adhesive sheet structure.

The adhesive sheet may be a double-coated adhesive sheet. In such a case, the substrate has the second adhesive layer on the other main surface of the support, and the adhesive sheet can be peeled from the image-recordable liner in the form of a double-coated adhesive sheet having the first and second adhesive layers on the substrate.

The substrate of the adhesive sheet is usually a polymer sheet or a film. The polymer forming the substrate may be a synthetic polymer such as polyester, polyvinyl chloride, ionomers, acrylic polymers, polyolefin, polyurethane. The substrate may be a laminated one having two or more layers. The substrate may contain additives such as a heat stabilizer, a UV-ray absorber, an antistatic agent, an antioxidant, a dye, a pigment.

The adhesive sheet of the adhesive sheet structure may be an adhesive sheet for overlamination. In this case, the adhesive as a whole (including the substrate and the adhesive layer(s)) has a high light transmission, and used with being adhered to the medium on which the image is already recorded. The adhesive layer is preferably adhered to the support of the medium through the image with a sufficient peel strength so that the adhesive layer is not delaminated from the support of the medium in use. Since the support of the medium is usually made of a polymer film such as polyvinyl chloride, polyester, polypropylene, the adhesive layer having the adhesion property as described above with such a polymer film is preferably used. The adhesive layer usually comprises a self-adherent polymer, and may optionally contain other additives such as a crosslinking agent, a plastcizer, a tackifying agent, a crystalline polymer. The self-adherent polymer may be an acrylic polymer, a nitrile-butadiene copolymer (e.g. NBR), an amorphous polyurethane, a silicone polymer. The self-adherent polymers may be used singly or as a mixture of two or more of them.

When the adhesive sheet is a double-coated one, the second adhesive layer is preferably protected with the second liner. In this case, the second liner may be the image-recordable liner or the conventional liner having no recording layer. When the second liner is the conventional liner, the adhesive sheet is suitable for producing the roll-form adhesive sheet structure having the rolled laminate structure. That is, the double-coated adhesive sheet having the first adhesive layer which is protected with the image-recordable liner as the first liner and the second adhesive layer which is protected with the conventional liner as the second liner, is produced in the form of an elongated sheet, and it is rolled up with allowing the back surface of the second liner (the main surface opposite to the release layer) in contact with the recording surface of the recording layer of the image-recordable liner. The roll-form adhesive sheet structure is preferable since it can be unwound from the roll and then cut to obtain an adhesive sheet having a specific length, or a certain length of the structure is printed while it is unwound from the roll. In the former case, preferably only the adhesive sheet is cut, while the image-recordable liner is rewound without cutting and stored and subsequently it is unwound and cut to form an image-recording medium having a specific length.

The total thickness of the adhesive sheet is usually from 50 to 400 μm, preferably from 70 to 350 μm. The thickness of the substrate is usually from 40 to 250 μm, preferably from 50 to 200 μm. The thickness of the adhesive layer is usually from 10 to 250 μm, preferably from 12 to 200 μm. In the case of the double-coated adhesive sheet, the thickness of each adhesive layer is adequately selected in the above thickness range of the adhesive layer so that the total thickness of the adhesive sheet is in the above range.

### EXAMPLES

### Example

An adhesive sheet structure of this Example was produced using an overlaminate film SP 4583 for “Scotch® Printing System” (available from 3M). This overlaminate film was a double-coated adhesive sheet, and thus had two adhesive layers, which were protected with conventional liners. Each of the conventional liners comprised a substrate of a PET film and a release layer formed from a release agent composition containing a silicone polymer. The total thickness of the liner was 75 μm.

One of the above adhesive layers was usually used as an adhesive layer to cover an image on an image-displaying sheet, while the other was usually used as an adhesive layer to fix the image-displaying sheet to a transparent adherent such as a pane through the overlaminate film.

On the back surface of one of the conventional liners, a coating composition containing a polyester resin (Vylon® 24SS available from TOYOBO) was applied with a knife coater and dried at 65° C. for 2 minutes and then at 105° C. for 2 minutes to form a recording layer having a dry thickness of 20 μm. Thereby, the image-recordable liner of this Example, which comprised one conventional liner and the recording layer formed on one main surface (back surface) of the one conventional liner, was formed, and the adhesive sheet structure comprising this image-recordable liner was obtained.

The double-coated adhesive sheet used in this Example had the following two adhesive layers. That is, the adhesive layer, which was protected with the above image-recordable liner, contained an acrylic self-adherent polymer and a crosslinking agent and had a thickness of 15 μm. The other adhesive layer, which was protected with the conventional liner, contained an acrylic self-adherent polymer and a crosslinking agent and had a thickness of 30 μm. The substrate of the double-coated adhesive sheet was a polyvinyl chloride film having a thickness of 50 μm, and a light transmittance of 90% (which was measured from the side of the other adhesive layer). One adhesive layer protected with the image-recordable liner had a peel strength at 20° C. of 20 N/25 mm (the adhesion strength against the stoved malamine coated plate measured by the method described above). Herein, the stoved melamine coated plate used was a stoved melamine coated plate available from PALTEC.

Next, with the adhesive sheet structure of this Example, the printing suitability was evaluated. Firstly, an image for transfer was formed on a transfer medium 8601 J (available from 3M) using the Scotch® Printing 9512 System. The image-carrying surface of this transfer medium and the recording surface of the image-recordable liner of the adhesive sheet structure were allowed in contact each other and the adhesive sheet structure was passed through a heat laminator OLCA® III (an image-thermal-transfer equipment available from 3M) under the following conditions to record the image on the image-recordable liner. A clear image was transferred on the liner. Thus, the image-displaying sheet having the above overlaminate film was obtained.

Image transfer conditions:

Upper roll temperature: 125° C.

Lower roll temperature: 55° C.

Speed: 60 cm/min.

Pressure: about 480 kPa (70 psi)

The image-displaying sheet was peeled from the adhesive sheet structure at a peeling angle of about 180 degrees. The overlaminate film (the other conventional liner) and the image-displaying sheet (the recorded image-recordable liner) could be easily separated, and no self-adherent polymer was left on the release surface of the release layer of the image-displaying sheet.

The image on the recording layer was clearly seen, when it was observed through the release layer and the support of the image-displaying sheet. The light transmittance of the whole image-recordable liner was 90% (measured from the release layer side). The image-displaying sheet of this Example had sufficient strength and toughness, and could be used as a poster or a banner film without breakage.

The image-recordable liner was once removed and separated from the adhesive sheet structure, press adhered again to the double-coated sheet, and subjected to the above releasing test of the image-recordable liner. The double-coated adhesive sheet could be peeled from the liner without the transfer of the self-adhesive polymer to the release layer of the image-recordable liner.

For comparison, an image was transferred to the conventional liner in the same was as in the above Example without forming a recording layer. However, the image was hardly transferred and unclear.

1. An image-recordable liner comprising
(a) a support having two main surfaces,
(b) a release layer which is fixed to one of the main surfaces of said support and comprises a release agent composition; and
(c) a recording layer which consists of a layer comprising a resin fixed to the other main surface of said support and receives an ink or a toner for recording an image.

2. The image recordable liner according to claim 1, which is used as a liner of an adhesive sheet comprising an adhesive layer which contains self-adherent polymer, wherein said liner can be peeled off from said adhesive sheet whiteout said self-adherent polymer being transferred to said release layer, after laminating said adhesive layer and said release layer, press adhering said adhesive sheet and said image-recordable liner with reciprocating a roller of 2 kg two times over them to form a laminate and then maintaining the laminate at 20° C. for 48 hours.

3. The image-recordable liner according to claim 1, which has a light transmittance of at least 70% when measured with illuminating said liner from the side of said release layer.

4. An adhesive sheet structure comprising
(A) a substrate having two main surfaces,
(B) at least one adhesive layer which is fixed to one of the main surfaces of said substrate and contains a self-adherent polymer, and
(C) an image-recordable liner according to claim 1, which is laminated on said adhesive layer with said release layer facing to said adhesive layer.

5. An image-recording medium comprising
(a) a support having two main surfaces,
(b) a release layer which is fixed to one of the main surfaces of said support and comprises a release agent composition, and
(c) a recording layer which consists of a layer comprising a resin fixed to the other main surface of said support and receives an ink or a toner for recording an image wherein said release agent composition comprises a slicone polymer, and said medium has a light transmittance of at least 70% when measured with illuminating said medium from the side of said release layer.
